(19) United States
(12) Patent Application Publication
(10) Pub. No.: US 2012/0191994 A1
(43) Pub. Date: Jul. 26, 2012

(54) ELECTRONIC DEVICE, STORAGE MEDIUM AND METHOD FOR SAVING POWER OF THE ELECTRONIC DEVICE

(75) Inventor: JIE SUN, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/313,002

(22) Filed: Dec. 7, 2011

(30) Foreign Application Priority Data
Jan. 25, 2011 (CN) 201110027286.9

(51) Int. Cl. G06F 1/32

(52) U.S. Cl. 713/320

(57) ABSTRACT

In a method for saving power of an electronic device, a power saving mode is defined for saving power of the electronic device, and a plurality of power configurations for the power saving mode are set. The method invokes the power saving mode of the electronic device, and determines whether the electronic device is in the power saving mode when the electronic device executes functions or applications of the electronic device. If the electronic device is in the power saving mode, the power configurations of the power saving mode are executed. If the electronic device is in a normal mode saving mode, normal configurations of the normal mode of the electronic device are executed.

### BACKGROUND

1. Technical Field

Embodiments of the present disclosure relate to power systems and methods, and more particularly to an electronic device, a storage medium, and a method for saving power of the electronic device.

2. Description of Related Art

Standby time is very important for users of mobile phones, especially dual-Subscriber Identity Module (SIM) phones. A display screen, a battery, loudspeaker, other elements or software of a mobile phone may affect the standby time of the mobile phone. Therefore, power saving is very important. The mobile phone may include a plurality of profiles for different circumstances that the user may select, such as a standard mode, a silent mode, a meeting mode, and a user-defined mode, for example. However, these profiles just relate to call and receive settings, volumes and key tones of the mobile device, and do not consider the power saving of the electronic device automatically.

### BRIEF DESCRIPTION OF THE DRAWINGS

FIG. 1 is a block diagram of one embodiment of an electronic device including a power saving system.

FIG. 2 is a flowchart of one embodiment of a method for saving power of the electronic device of FIG. 1.

FIG. 3 is a detailed flowchart of block S12 in FIG. 2.

FIG. 4 is an exemplary flowchart of one embodiment of the electronic device receiving an incoming call.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

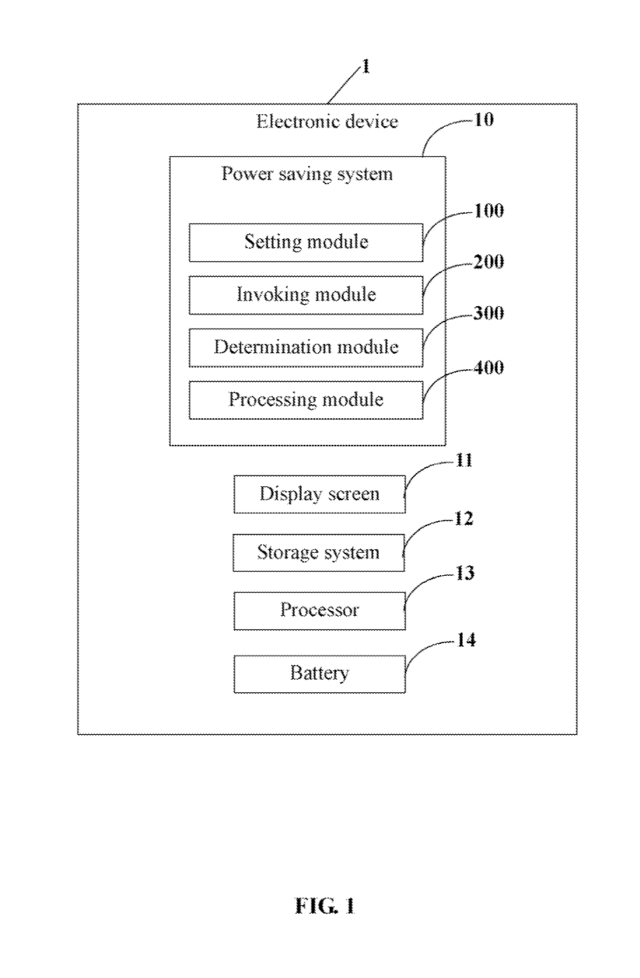

FIG. 1 is a block diagram of one embodiment of an electronic device 1 including a power saving system 10. In one embodiment, the electronic device 1 may be a mobile phone, or a dual-Subscriber Identity Module (SIM) phone, for example. The power saving system 10 may define a power saving mode for the electronic device 1 to reduce power consumed by the electronic device 1, and automatically remind the user of the electronic device 1 to start the power saving mode when a remaining battery power of the electronic device 1 is low.

The electronic device 1 includes a display screen 11, a storage system 12, at least one processor 13 and a battery 14. The display screen 11 may display data messages, or images of the electronic device 1, for example. The battery 14 provides power of the electronic device 1. The storage system 12 may store data of the electronic device 1. The storage system 12 may be a memory of the electronic device 1, or an external storage card, such as a smart media card, or a secure digital card. The at least one processor 13 executes one or more computerized codes and other applications of the electronic device 1, to provide functions of the power saving system 10.

In the embodiment, the power saving system 10 may include a setting module 100, an invoking module 200, a determination module 300, and a processing module 400. The modules 100, 200, 300, and 400 comprise computerized codes in the form of one or more programs that are stored in the storage system 12. The computerized codes include instructions that are executed by the at least one processor 13 to provide functions for the modules. Details of these operations follow.

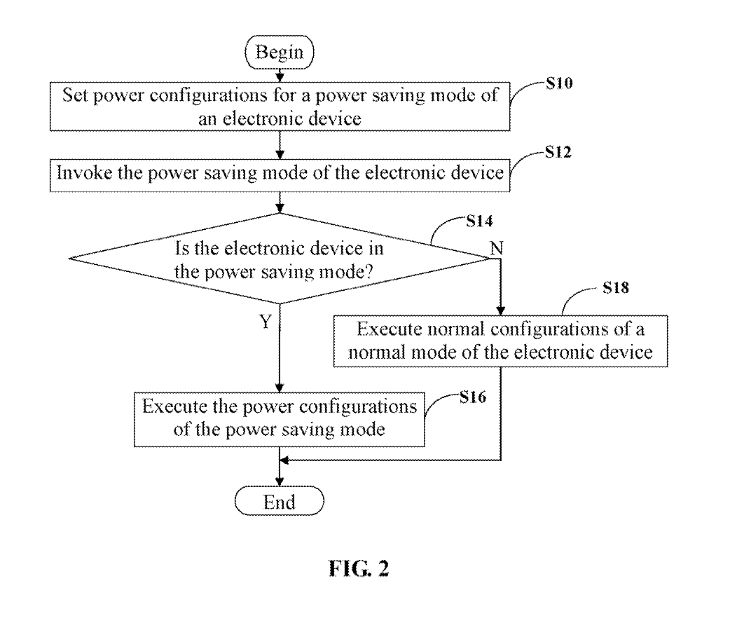

FIG. 2 is a flowchart of a second embodiment of a method for saving power of the electronic device 1 of FIG. 1. Depending on the embodiment, additional blocks may be added, others deleted, and the ordering of the blocks may be changed.

In block S10, the setting module 100 defines a power saving mode for the electronic device 1 to save power of the electronic device 1, and sets a plurality of power configurations for the power saving mode. In one embodiment, if the electronic device 1 is not in the power saving mode, the electronic device 1 is defined as being in a normal mode. The normal mode may be a standard mode, a silent mode, a meeting mode, or a user-defined mode. The normal mode is a profile that does not offer any power saving function of the electronic device 1. The normal mode may include a plurality of normal configurations that are different from settings of the power configurations of the power saving mode. If the electronic device 1 is the dual-SIM phone, the setting module 100 may set the power configurations for both of the SIM cards of the electronic device 1.

In one embodiment, both the power configurations and the normal configurations include a plurality of functional items to set. The functional items may include settings of functional items of the electronic device 1, such as settings of incoming calls, a duration time of a backlight of the display screen 11, a vibration function, prompt tones of keys and starting up/off of the electronic device 1. The functional items may further include settings of adjusting a clocking frequency, disabling one SIM card, and a waiting time of a Bluetooth or a camera of the electronic device 1. For example, the power configurations may set the incoming calls with a ringing volume of 5 grade volume and a only once ringing, and set the duration time of the backlight to be 5 seconds. In comparison with the power saving mode, the normal configurations may set the incoming calls with the ringing volume of 7 grade volume and a continuous ringing, and set the duration time of the backlight to be 15 seconds. The power configurations may disable the vibration function and the prompt tones, and the normal configurations may enable the vibration function and the prompt tones. If the electronic device 1 is the dual-SIM phone, the power configurations may set to disable one SIM card of the electronic device 1, the normal configurations may set to enable two SIM cards of the electronic device 1. Furthermore, functional items of the power configurations and the normal configurations may include other settings of the electronic device 1, and may be set according to user preference.

In block S12, the invoking module 200 invokes the power saving mode of the electronic device 1. In one embodiment, the invoking module 200 prompts the user of the electronic device 1 to start the power saving mode on the display screen 11 when a voltage value of the battery 14 of the electronic device 1 is in a low power state. For example, the invoking module 200 displays a message of “The power saving mode should be started” on the display screen 11 to prompt the user. The invoking module 200 may invoke the power saving mode according to the preference of the user. Details will be described.

In block S14, the determination module 300 determines whether the electronic device 1 is in the power saving mode, when the electronic device 1 executes functions or applications of the electronic device 1, such as, when the electronic device 1 is making calls, writing and sending text message, playing music, for example.

If the electronic device 1 is determined to be in the power saving mode, in block S16, the processing module 400 executes the power configurations of the power saving mode.

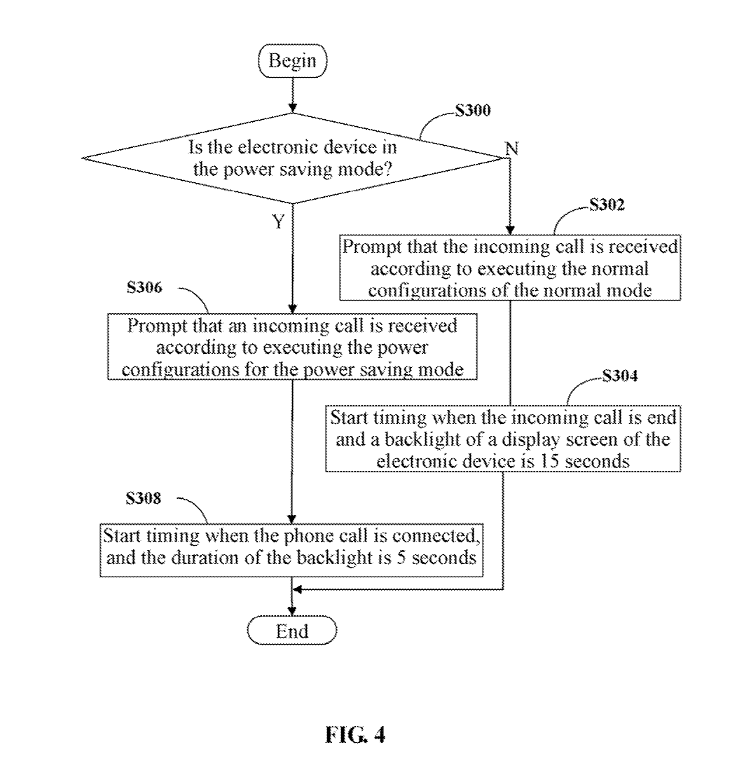

If the electronic device 1 is determined in the normal mode, in block S18, the processing module 400 executes the normal configurations of the normal mode. An exemplary of the executing the configuration will be described in FIG. 4.

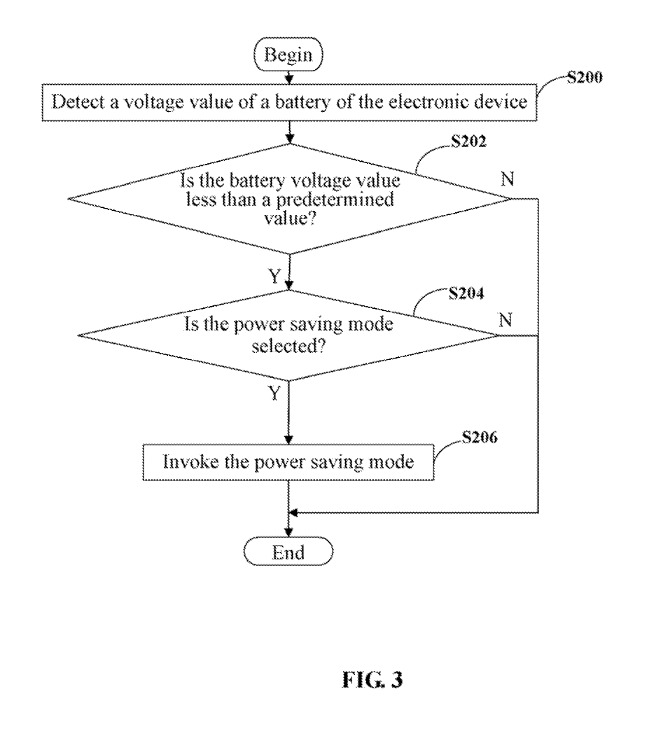

FIG. 3 is a detailed flowchart of block S12 in FIG. 2. Depending on the embodiment, additional blocks may be added, others deleted, and the ordering of the blocks may be changed.

In block S200, the invoking module 200 detects the voltage value of the battery 14 of the electronic device 1 at predetermined time intervals.

In block S202, the invoking module 200 determines whether the voltage value of the battery 14 is less than a predetermined value. The predetermined value is a threshold value to determine whether the electronic device 1 is in the low voltage state. For example, if a power-off voltage value is about 3.5V, the predetermined value may be set at 3.6V. If the voltage value of the battery is equal to or greater than the predetermined value, the procedure ends.

If the voltage value of the battery is less than the predetermined value, in block S204, the invoking module 200 prompts a user of the electronic device 1 whether to select the power saving mode or not on the display screen 11, to indicate that the electronic device 1 is in the low voltage state. For example, the invoking module 200 may display a message of “low power, start the power saving mode or not?”, and offer two choices “yes” or “no” to the electronic device 1. The invoking module 200 further determines whether the power saving mode has been selected. If the power saving mode has not been selected within a certain time, the procedure is ended.

If the user has selected to start the power saving mode, in block S206, the invoking module 200 invokes the power saving mode.

FIG. 4 is an exemplary flowchart of one embodiment of the electronic device receiving an incoming call. In block S300, when an incoming call is received, the determination module 300 determines whether the electronic device 1 is already in the power saving mode. If the electronic device 1 is already in the power saving mode, block S306 is implemented.

If the electronic device 1 is in the normal mode, in block S302, the processing module 400 prompts that the incoming call is being received according to execution of the normal configurations, so that, for example, the ringing volume of the incoming call as 7 grade volume and continuous ringing.

In block S304, when the incoming call is ended, the processing module 400 starts to time the duration of the backlight until 15 seconds are elapsed, and the procedure ends.

In block S306, the processing module 400 prompts that the incoming call is being received according to execution of the power configurations, such as, the ringing volume of the incoming call as 5 grade volume and ringing only once.

In block S308, when the incoming call of the electronic device 1 is accepted by the user, the processing module 400 starts to time the duration of the backlight until 5 seconds are elapsed.

All of the processes described above may be embodied in, and fully automated via, functional code modules executed by one or more general purpose processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital versatile disc, a tape drive or other suitable storage medium.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. An electronic device, comprising:
a display screen;
a storage system;
at least one processor; and
one or more programs that are stored in the storage system and executed by the at least one processor, the one or more programs comprising:
a setting module operable to define a power saving mode for the electronic device, and set a plurality of power configurations for the power saving mode;
a invoking module operable to invoke the power saving mode of the electronic device;
a determination module operable to determine whether the electronic device is in the power saving mode, upon the condition that the electronic device executes applications of the electronic device;
a processing module operable to execute the power configurations of the power saving mode if the electronic device is in the power saving mode, or execute normal configurations of a normal mode of the electronic device if the electronic device is not in the power saving mode.

2. The electronic device as claimed in claim 1, wherein the invoking module invokes the power saving mode by steps of:
detecting a voltage value of a battery of the electronic device;
determining whether the voltage value of the battery is less than a predetermined value, wherein the predetermined value is a threshold value for determining whether the electronic device is in a low voltage state;
displaying a message on the display screen indicating to start the power saving mode upon the condition that the battery value is less than the predetermined value.

3. The electronic device as claimed in claim 1, wherein the normal mode is selected the group consisting of a standard mode, a silent mode, a meeting mode, and a user-defined mode.

4. The electronic device as claimed in claim 1, wherein the normal mode comprises a plurality of normal configurations with different settings from the power configurations of the power saving mode.

5. The electronic device as claimed in claim 4, wherein both the power configurations and the normal configurations comprises a plurality of functional items of the electronic device.

6. A computer-implemented method for saving power of an electronic device, the method comprising:
defining a power saving mode for the electronic device, and setting a plurality of power configurations for the power saving mode;
invoking the power saving mode of the electronic device;
in response to the electronic device executing applications of the electronic device, determining whether the electronic device is in the power saving mode;
executing the power configurations of the power saving mode if the electronic device is in the power saving mode; or
executing normal configurations of a normal mode of the electronic device if the electronic device is not in the power saving mode.

7. The method as claimed in claim 6, wherein the power saving mode is invoked by steps of:
detecting a voltage value of a battery of the electronic device;
determining whether the voltage value of the battery is less than a predetermined value, wherein the predetermined value is a threshold value for determining whether the electronic device is in a low voltage state;
displaying a message on the display screen indicating to start the power saving mode upon the condition that the battery value is less than the predetermined value.

8. The method as claimed in claim 6, wherein the normal mode is selected the group consisting of a standard mode, a silent mode, a meeting mode, and a user-defined mode.

9. The method as claimed in claim 6, wherein the normal mode comprises a plurality of normal configurations with different settings from the power configurations of the power saving mode.

10. The method as claimed in claim 9, wherein both the power configurations and the normal configurations comprises a plurality of functional items of the electronic device.

11. A non-transitory storage medium storing a set of instructions, the set of instructions capable of being executed by at least one processor of an electronic device, causes the at least one processor to perform a method for saving power of the electronic device, the method comprising:
defining a power saving mode for the electronic device to save power of the electronic device, and set a plurality of power configurations for the power saving mode;
invoking the power saving mode of the electronic device;
in response to the electronic device executing applications of the electronic device, determining whether the electronic device is in the power saving mode;
executing the power configurations of the power saving mode if the electronic device is in the power saving mode; or
executing normal configurations of a normal mode of the electronic device if the electronic device is not in the power saving mode.

12. The storage medium as claimed in claim 11, wherein the power saving mode is started by detecting a voltage value of the battery of the electronic device;
determining whether the voltage value of the battery is less than a predetermined value, and the predetermined value is a threshold value to determine whether the electronic device is in a low voltage state;
displaying a message on the display screen indicating to start the power saving mode upon the condition that the battery value is less than the predetermined value.

13. The storage medium as claimed in claim 11, wherein the normal mode is selected the group consisting of a standard mode, a silent mode, a meeting mode, and a user-defined mode.

14. The storage medium as claimed in claim 11, wherein the normal mode comprises a plurality of normal configurations with different settings from the power configurations of the power saving mode.

15. The storage medium as claimed in claim 14, wherein both the power configurations and the normal configurations comprises a plurality of functional items of the electronic device.

16. The storage medium according to claim 11, wherein the storage medium is selected from the group consisting of a hard disk drive, a compact disc, a digital video disc, and a tape drive.
